(19) United States
(12) Patent Application Publication
(10) Pub. No.: US 2015/0227969 A1
(43) Pub. Date: Aug. 13, 2015

(54) SYSTEMS AND METHODS FOR MANAGING SEATING LOCATIONS AND PREFERENCES

(71) Applicant: STUBHUB, INC., San Francisco, CA (US)

(72) Inventor: Amy Colleen Hanly, San Jose, CA (US)

(21) Appl. No.: 14/178,142

(22) Filed: Feb. 11, 2014

(51) Int. Cl. G06Q 30/02

(52) U.S. Cl. CPC G06Q 30/0252

(57) ABSTRACT

A system or method is provided to determine a location preference of a user in a public event. A location and movement of the user in the public event, e.g., a concert hall or a stadium, may be monitored by detecting a location of the user's mobile device via Bluetooth Low Energy (BLE) communication using a network of BLE devices, such as beacons, positioned throughout the public event. In particular, a seating location of the user may be determined via BLE. The system may collect the user's locations and movements in the public event to determine user preference, such as seating or event preference. The location and event preference of the user may be used to generate targeted offers or advertisements specific for the user. For example, the system may analyze the seat location of the user and may offer tickets for similar seat locations and events to the user.

### BACKGROUND

1. Field of the Invention

The present invention generally relates to systems and methods for managing seating locations and preferences in public events.

2. Related Art

With modern technology, consumers have access to various marketplaces and merchants to make purchases. For example, event tickets for entertainment or sporting events are made available to consumers via online stores. An online merchant may wish to send offers or advertisements for event tickets to customers. Nevertheless, it may be difficult to determine each customer's event or seating preferences. For example, without a customer's input, it may be difficult to determine what type of sporting or entertainment events a customer is interested in and what kind of seating is preferred by the customer. Therefore, the merchant typically sends mass advertisements or offers for event tickets that the customer may not be interested in. As such, the customers may consider these mass advertisements or offers as spam mails that junk up their inboxes. Accordingly, there is a need for a system or method that helps determine a customer's event and seating preferences to provide better offers to the customer.

### BRIEF DESCRIPTION OF THE FIGURES

FIG. 1 is a block diagram of a networked system suitable for managing seating locations and preferences according to an embodiment.

FIG. 2 is a flowchart showing a process of collecting user preferences according to one embodiment.

FIG. 3A is a flowchart showing a process for generating user-specific offers according to one embodiment.

FIG. 3B is a flowchart showing a process for generating event directions according to one embodiment.

FIG. 4 is a block diagram of a computer system suitable for implementing one or more components in FIG. 1 according to one embodiment.

FIG. 5 is a diagram depicting a layout of a seating section in a public event according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or method is provided to determine a location preference of a user in a public event. A location and movement of the user in the public event, e.g., a concert hall or a stadium, may be monitored by Bluetooth Low Energy (BLE) communication using a network of BLE devices, such as beacons, positioned throughout the public event. In particular, a seating location of the user may be determined via BLE. The system may collect the user's locations and movements in the public event to determine user preferences, such as seating or event preference.

In an embodiment, the preferences of the user may be used to generate targeted offers or advertisements specific for the user. For example, the system may analyze the seat location history of the user and may offer tickets for similar seat locations and events to the user. The location of the user in the public event also may be used in combination with the user's social network information to find the user's friends who are attending the same public event. For example, the system may locate the user's friends in the stadium, find seats near where the friends are sitting, and offer these seats to the user, such that the user may sit near the friends.

In another embodiment, the system may detect via BLE that the user is not sitting in the assigned seat and may offer to sell the ticket for the assigned seat to others near or at the public event. Thus, the user may be able to offer his or her ticket for sale in real time when the user decides not to use the assigned seat. In still another embodiment, the system may provide directions and guidance to various amenities in the public event. For example, the system may guide a user to his or her assigned seat via BLE. The system also may guide the user to the closest restroom, food vendors, merchandise vendors, and the like using BLE.

In yet another embodiment, the system may determine the location of the user in the public event and may poll the user regarding the location. For example, the system may provide an interface for the user to rate the quality of the seat, the view, accessibility to amenities, crowd dynamic, etc. The system may collect this information for future reference. In another embodiment, the system may monitor crowd traffic flow via BLE and may suggest the best route for a user to take. For example, at the end of a public event, the system may provide the least congested route for a user to exit the stadium. Thus, the system may provide an efficient way for the crowd to orderly and safely exit the stadium. In another example, when the user's assigned seat is in the middle of a row, the system may determine which end of the row has less occupied seats and is better for accessing the assigned seat.

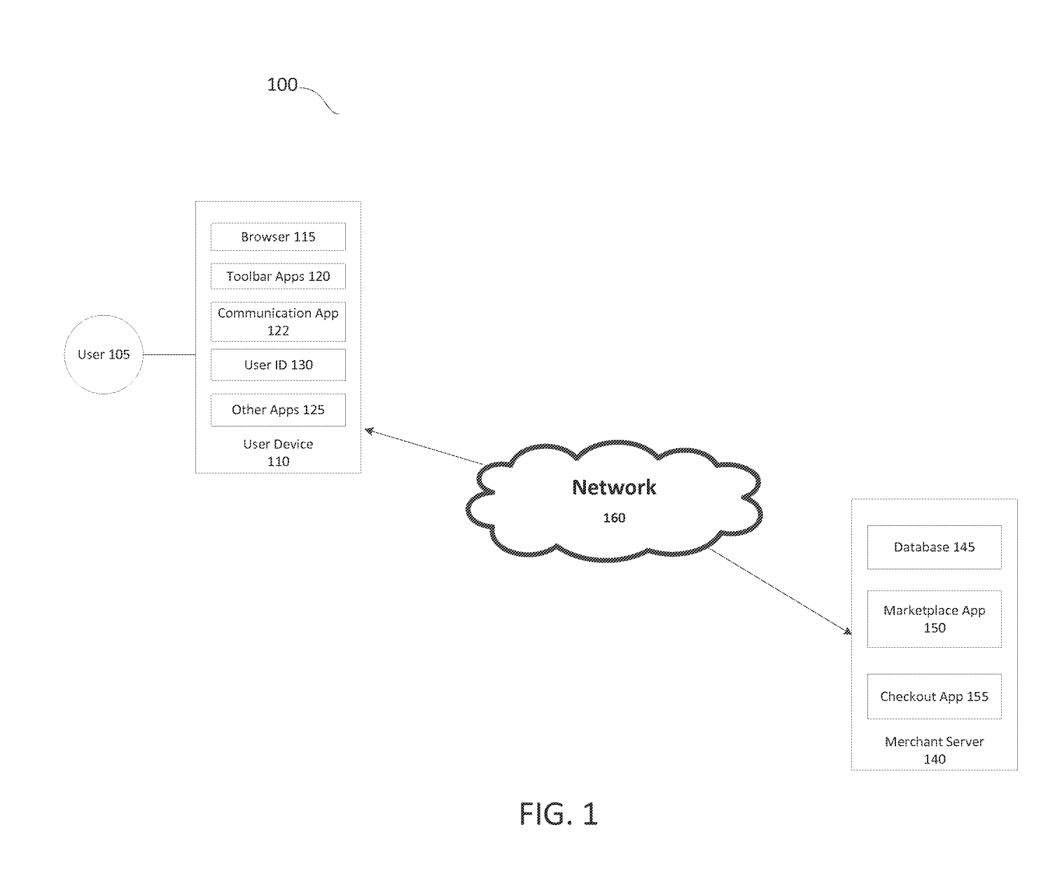

FIG. 1 is a block diagram of a networked system 100 suitable for implementing a process for managing seating locations and preferences according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110 and a merchant server 140 in communication over a network 160. Merchant server 140 may be maintained by a ticket exchange service provider, such as StubHub, Inc. of San Francisco, Calif. A user 105, such as a sender or consumer, may utilize user device 110 to search and purchase event tickets using merchant server 140. A user 105 may utilize user device 110 to browser, find, and pay for a ticket using merchant server 140. For example, a ticket purchase application provided by the ticket exchange service provider may be installed at user device 110 to facilitate ticket purchase by connecting user device 110 to merchant device 110 via network 160.

User device 110 may include a Bluetooth device configured to implement low energy Bluetooth communication. A network of low energy Bluetooth beacons may be installed at various locations inside the public event, such as a concert hall or a stadium. Thus, the location and movements of user device 110 in the public event may be determined by detecting the various Bluetooth beacons installed in the merchant's store.

User device 110 and merchant server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160. User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a ticket exchange service provider to associate user 105 with a particular account maintained by the ticket exchange service provider. A communications application 122, with associated interfaces, enables user device 110 to communicate within system 100.

User device 110 may include a Bluetooth device configured to implement low energy Bluetooth (BLE) communication. For example, user device 110 may detect various low energy Bluetooth signals from Bluetooth beacons installed in public event. Thus, locations and movements of user device 110 may be determined by positioning techniques, such as triangulation or location fingerprinting, based on the received BLE signals.

User derive 110 also may collect location data using Global Positioning System (GPS) to identify a location of user device 110. Other means for collecting location data, such as WiFi devices, Near-Field Communication (NFC) devices, or the like also may be included in user device 110 for determining a location of user device 110. Thus, user device 110 may determine a current location of user device 110 based on the collected location data. In another embodiment, user device 110 may send the location data to merchant server 140 and merchant server 140 may determine a current location of user device 110 based on the location data. These positioning techniques may be used in combination with BLE communication to provide dynamic positioning of user's location.

Merchant server 140 may be maintained, for example, by a ticket exchange service provider offering various event tickets. The ticket exchange service provider may have a physical point-of-sale (POS) store front and/or an online store. The ticket exchange service provider merchant may provide a marketplace for facilitating buying and selling of various event tickets between buyers and sellers.

Merchant server 140 may include a database 145 identifying available event tickets, which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser 115 or ticket purchase application over network 160 in order to view various event tickets identified in database 145.

Merchant server 140 also may include a checkout application 155 which may be configured to facilitate the purchase by user 105 of event tickets. Checkout application 155 may be configured to accept payment information from or on behalf of user 105 through a payment service provider over network 160. For example, checkout application 155 may receive and process a payment confirmation from the payment service provider, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Merchant server 140 may be connected to a network of Bluetooth beacons installed in a public event location, such as a concert hall or a stadium. The network of Bluetooth beacons may be installed at respective locations throughout the public event to form a grid. Each Bluetooth beacon may emit a low energy Bluetooth signal in specific frequency spectrum periodically. Thus, the network of Bluetooth beacons may allow detection of locations and movements of customers in the public event. In an embodiment, the network of Bluetooth beacons may be connected to merchant server 140 remotely via network 160.

Merchant server 140 may maintain a database including the location of each Bluetooth beacons in the public event. Thus, based on the location of the detected Bluetooth beacons, the location of a user may be determined by triangulation or location fingerprinting. Further, the database may include a layout of the public event, such as the seating charts and overall maps of stadiums or concert halls. The respective locations of the network of Bluetooth beacons may be included in the map or layout of the public event. Thus, merchant server 140 may determine various locations, such as seat location or amenity location in the public event with respect to the network of Bluetooth beacons.

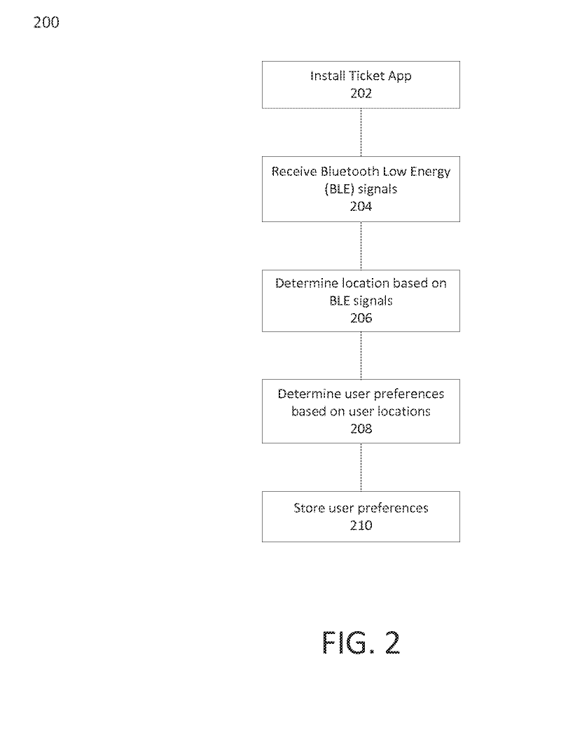

FIG. 2 is a flowchart showing a process 200 for collecting user preferences according to one embodiment. At step 202, a ticket purchase app may be installed on user device 110. For example, user 105 may visit the ticket exchange service provider's website or a mobile app store to download the ticket purchase application. The operating system of user device 110 may install the ticket purchase application. The ticket purchase application may facilitate ticket purchase at the ticket exchange provider. In particular, the ticket purchase application may connect user device 110 to merchant server 140 and may allow user device 110 to browse, search, and purchase event tickets offered at the ticket exchange service provider.

At step 204, user device 110 may receive Bluetooth Low Energy (BLE) signals from Bluetooth beacons located near user device 110. For example, a network of Bluetooth beacons may be installed throughout the stadium or concert hall of the public event. Each Bluetooth beacon may be installed at a specific location and may emit low energy Bluetooth signals. Thus, a grid of Bluetooth beacons may be formed at the public event.

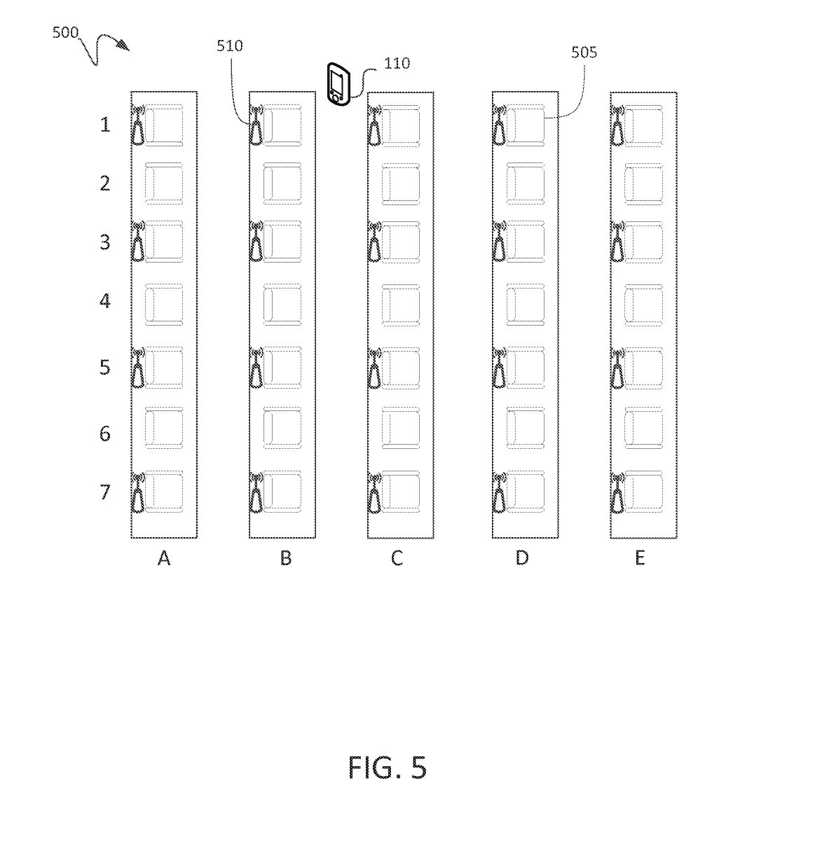

As shown in FIG. 5, as an example, a seating section 500 in a public event may include a plurality of seats 505. Seats 505 may be arranged in Rows 1-7 and Columns A-E. Each column may have four Bluetooth beacons 510: one at row 1, one at row 3, one at row 5, and one at row 7. Although the example has one Bluetooth beacon 510 for every other seat, other arrangements also may be implemented based on different requirements. For example, in other embodiments, every seat may include a Bluetooth beacon 510 or only one Bluetooth beacon 510 is used for each column. An increased number of Bluetooth beacons 510 installed in the public event may increase the accuracy and reliability of position detections. Nevertheless, an increased number of Bluetooth beacons 510 may increase cost. Thus, based on the needs of the application, appropriate number and layout of Bluetooth beacons 510 may be implemented.

Bluetooth beacons 510 also may be installed throughout the stadium at places, such as walkways, amenities, food/merchandise vendors, restrooms, parking lots, and the like to facilitate location detection. Bluetooth beacons 510 also may be installed at different levels of the stadium to form a three dimensional grid of Bluetooth beacon network. Thus, the location of a user may be determined with respect to both horizontal and vertical positions within the stadium.

The network of Bluetooth beacons 510 may be connected to merchant device 140. Each Bluetooth beacon 510 may emit a low energy Bluetooth signal with specific frequency spectrum. User 105 may carry a user device 110 including a Bluetooth device configured to communicate via low energy Bluetooth communication. When user 105 moves around seating section 500, user device 110 may detect Bluetooth beacons 510 installed in seating section 500. Thus, the position of user device 110 may be determined based on which Bluetooth signals are received and the respective signal strength of the signals.

The position of user device 110 may be determined using techniques, such as triangulation or location fingerprint. In the triangulation technique, the location of user device 110 may be determined based on the locations of two or more Bluetooth beacons 510 and the distance of user device 110 from the two or more Bluetooth beacons 510. The locations of the Bluetooth beacons 510 may be predetermined when the Bluetooth beacons 510 are installed in seating section 500. The distance between the Bluetooth beacons 510 and user device 110 may be determined based on the signal strength received between the Bluetooth beacons 510 and user device 110. For example, a stronger signal may indicate a shorter distance while a weaker signal may indicate a longer distance. Thus, based on the Bluetooth signals between the Bluetooth beacons 510 and user device 110, the location of user device 110 may be determined using the triangulation technique.

In the location fingerprint technique, a database of signal fingerprints at various locations in the stadium may be predetermined. For example, a signal profile may be predetermined for each location in the stadium. The signal profile may include Bluetooth signals that are detected at a specific location and the strength of each of those detected Bluetooth signals at the specific location. For example, at Column B-Row 1, a signal profile may be predetermined to indicate strong signals from Bluetooth beacons 510 installed at Column B-Row 1 and Column C-Row 1, and weak signals from Bluetooth beacons 510 installed at Column A-Row 1, Column B-Row 3, Column C-Row 3, and Column D-Row 1. A database of signal profiles associated with respective locations in the stadium may be predetermined and stored. Thus, based on a signal profile detected by user device 110, a location of user device 110 may be determined by referencing the database of signal profiles.

In some embodiments, the signal profile may be the Bluetooth signal of user device 110 received by respective Bluetooth beacons. For example, at Column B-Row 1, a signal profile may be predetermined to indicate strong signals received at Bluetooth beacons 510 installed at Column B-Row 1 and Column C-Row 1, and weak signals received at Bluetooth beacons 510 installed at Column A-Row 1, Column B-Row 3, Column C-Row 3, and Column D-Row 1. Thus, the signal fingerprints may be signals from Bluetooth beacons 510 received at user device 110 or signals from user device 110 received at the respective Bluetooth beacons 510.

The location of user device 110 may be determined by user device 110. For example, user device 110 may download a layout map of stadium and may determine user device 110's position based on the Bluetooth signals detected and the layout of the Bluetooth beacons 510. In some embodiments, merchant device 140 may determine the location of user device 110 based on which Bluetooth beacons 510 detect user device 110 and the strength of the signal detected at the Bluetooth beacons 510. In some embodiments, the detected signals and signal strengths may be forwarded to merchant device 140 and merchant device 140 may determine the location of user device 110.

The position of user device 110 may be monitored continuously, e.g., every few seconds, to track the movement of user device 110 in the store. Thus, a movement of user 105 at the public event may be monitored. By tracking the movement of customers in the stadium, the consumers' preferences may be analyzed to improve customer experience and increase sales. For example, by tracking consumer movements, the system may determine which amenities or food vendors are most and/or least visited by customers and where customers like to sit or spend time during the public event. These statistics may be used to suggest personally tailored advertisements or offerings to the customer. Further, advertisements or offerings also may be presented to the customer at proper locations in the stadium. For example, amenities, such as food vendors or restrooms, located near a customer's assigned seat may be suggested to the customer for convenience.

At step 208, user 105's preferences may be determined based on user 105's location and movements. The location of user 105's assigned seat may be determined based on user 105's location. For example, the location of user 105's assigned seat may be determined when user 105 is stationary at a particular seat for an extended amount of time. Thus, the system may determine that user 105 is seated at that particular seat. For example, if user 105 is stationary at a particular seat for more than 10 minutes during a football game, the system may determine that the particular seat is user 105's assigned seat. The likelihood that the particular seat is user 105's assigned seat may depend on how full the stadium is. For example, if the stadium is not full, user 105 is likely to find another empty seat to use even though the empty seat is not assigned to user 105. Thus, the probability that the particular seat is user 105's assigned seat may be adjusted based on how full the stadium is. Accordingly, even if user 105's event ticket was not purchased through the merchant, the merchant may still determine the assigned seat for the event ticket via the Bluetooth signals detected by user device 110.

The seat location of user 105 may be used to generate seating preference for user 105. The system may monitor and track a history of seating positions of user 105 at various public events. A seating position trend may be generated from the history of seating positions to determine a type or range of seating positions preferred by user 105. For example, based on user 105's seating history, the system may determine that user 105 prefers outfield seats in baseball games.

In an embodiment, the seating preference also may be inferred from the movement of user 105. For example, assuming that the system knows the position of user 105's assigned seat. Nevertheless, the system detects that user 105 frequently leaves the assigned seat to visit another seating section. The system may infer that user 105 may prefer another seating section over the assigned seat. Thus, the system may note this other seating section as a possible preferred seating position for user 105. The system may offer for user 105 to switch or upgrade from the original assigned seat to a seat in this other seating section.

In another embodiment, the movement of user 105 may be used to generate user preferences. For example, user 105 may travel to various amenities, such as food/merchandize vendors, restrooms, event tables during the public event. The system may track where user 105 visits during the public event to generate user preferences for different amenities. For example, the system may detect that user 105 visits a particular drink vendor during the public event. The system may determine that the particular drink vendor as user 105's preference. Thus, based on this user preference, the system may suggest similar vendors near user 105 to user 105.

In another embodiment, the system may track how user 105 navigates around the public event. For example, the system may monitor how user 105 enters and exits the stadium and how user 105 reaches his or her assigned seat from the entrance of the stadium. Thus, the system may use the user preference to suggest shorter or less congested routes for user 105.

At step 210, the user preferences may be stored for future reference. For example, the user preferences may be stored with their corresponding event tickets. The user preferences may be used to suggest event tickets to users for future events. In some embodiments, the user preferences may be used to generate personalized advertisements for public events.

By using the above process 200, a user's locations and movements in a public event may be monitored. In particular, seat location of the user may be detected via BLE beacons. The user's movements during the public event also may be monitored to determine user preferences for various vendors, amenities, routes, seats, and the like at the public event.

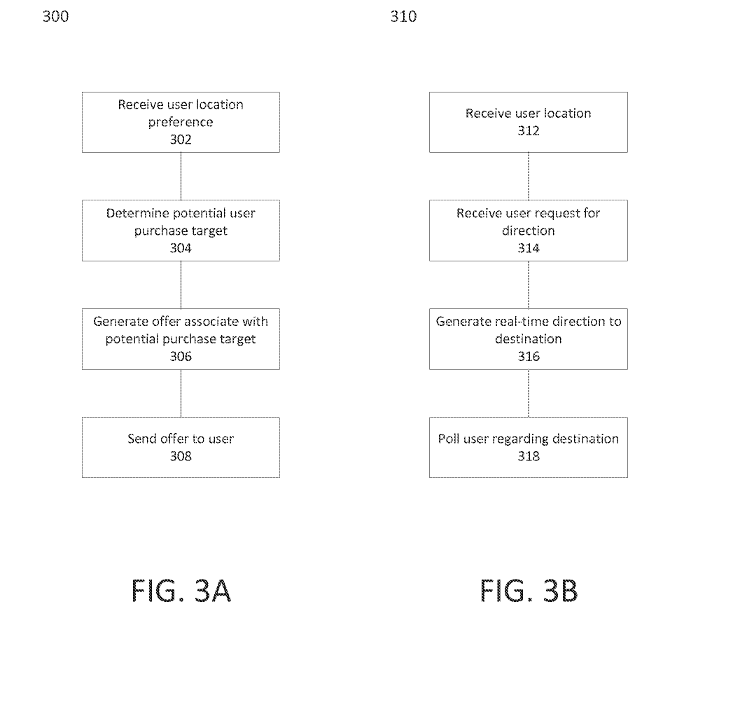

FIG. 3A is a flowchart showing a process 300 for generating user-specific offers according to one embodiment. At step 302, user location preference may be received. User 105's location preference may be determined and stored at a database by merchant server 140. Thus, user 105's location preference may be retrieved from the database.

At step 304, a potential purchase target may be determined. The potential purchase target may be determined from user 105's interaction with user device 110. In particular, the potential purchase target may be determined based on user 105's purchase history, browsing history, media taste, search history, and the like. For example, the system may detect that user 105 is using a web browser on user device 110 to search for a ticket for a baseball game in a particular city. Thus, the system may determine that the potential purchase target is a baseball ticket in the particular city.

In an embodiment, the system may determine that user typically attends a college basketball game in a particular city during March of the past few years. Thus, as the month of March approaches this year, the system may determine that the potential purchase target is a basketball game ticket this coming March in the particular city. As this March approaches, merchant server 140 may generate advertisements or offers for tickets to the college basketball game in the particular city to user 105 to remind and entice user 105 to purchase the tickets. The advertisements or offers may be sent via email, paper mail, text message, or the like to user 105. The system also may consider the tickets and seats previously purchased by user 105 to find similar tickets or seats preferred by user 105. Further, the system may check the availability of these tickets or seats preferred by user 105 and send the offers for these available tickets to user 105. Accordingly, the system may generate offers based on the potential purchase target at step 306 and send the offers to user 105 at step 308.

In an embodiment, after user 105 arrives at the public event, the locations and movements of user 105 may continue to be monitored to determine potential purchase target. For example, user 105 may leave his or her assigned seat and linger at an area different from user 105's seating section to be with user 105's friends or to have a better view of the event. The system may determine that user 105 is away from his or her assigned seat and may prefer the area where user 105 is lingering. Thus, the system may search in real time an available seat near the area where user 105 is lingering and may offer user 105 an upgrade to the available seat. For example, merchant server 140 may send a text message or an email to user device 110 stating: “Would you like a seat in this seating section?Upgrade now to Seat XXX for only $20.” User 105 may choose to upgrade to the seat in the preferred area. Further, the system may offer to sell user 105's original assigned seat to others, since user 105 no longer needs the original assigned seat.

With user 105's permission, the system may access user 105's social network and may determine whether any of user 105's friends also are attending the same public event. The system may determine user 105 and the friends seating locations via BLE beacons. The system may offer to find seats in real time, such that user 105 and the friends may be seated near each other. In particular, the system may provide a user interface to allow user 105 to control whether and how user 105 is discoverable by others in the public event. For example, user 105 may change the setting such that user 105's location is discoverable by only friends. Thus, only friends may discover user 105's location in the public event via BLE beacons. When user 105 prefers privacy during the public event, user 105 may change the setting such that user 105 is not discoverable by anyone. Thus, user 105 may enjoy the public event without distractions.

Based on user 105's preference, the system may suggest various amenities in the public event to user 105. For example, the system may show user 105 on user device 110 various food/merchandize vendors near user 105's location. In particular, food/merchandize vendors that match user 105's preference may be presented to user 105. For example, based on user's purchase history, the system may determine that user 105 likes to collect basketball caps. The system may determine user 105's location via BLE beacon and may present basketball cap vendors near user 105's location to user 105. Further, based on user 105's current location, the system may help navigate user 105 to the vendor. For example, step-by-step directions to the vendor may be presented to user in real time.

In an embodiment, when user 105 leaves the original assigned seat, either by leaving the public event or by upgrading to another seat, the system may detect that user 105 no longer is at the originally assigned seat and offer to sell the originally assigned seat to another person. For example, the system may determine that user 105 has been gone from the originally assigned seat for more than 30 minutes and may send a notification to user 105 stating: “You have left your original assigned seat XXX for more than 30 minutes. Do you still need this seat? Would you like to sell this seat to another person for $100?” Thus, the system may allow the sales of an unused seat in real time during the public event.

By using the above process 300, a potential purchase target may be determined based on user's preferences. Thus, customer-specific offers may be generated from the potential purchase target to better target the customer's interests. The offers may be presented to the customer to entice the customer to purchase tickets to a public event. Further, when the customer is attending the public event, additional offers may be presented to the customer based on the location and movement of the customer in the public event. The offers may include suggestions for various vendors and seat upgrades.

FIG. 3B is a flowchart showing a process for generating event directions according to one embodiment. At step 312, merchant server 140 may receive user 105's location in the public event via BLE beacons installed throughout the public event. At step 314, merchant server 140 may receive user 105's request via user device 110 for directions to a particular location in the public event. For example, user device 110 may include a user interface presenting user 105's location relative to amenities or seating locations within the stadium. User 105 may select a destination on user device 110 and the system may generate real-time direction to the selected destination at step 316.

The system may generate directions to help navigate user 105 in the public event based on user preferences or based on user instructions. For example, based on user 105's position and the location of user 105's assigned seat, the system may generate directions to help user 105 reach the assigned seat when user 105 just arrived at the public event. In particular, the system may determine crowd traffic to find a shortest and least congested route to user 105's assigned seat. For example, as shown in FIG. 5, assuming that user 105's assigned seat is Column C-Row 4. The assigned seat may be accessed via either ends of Column C. The system may determine, based on BLE beacons, whether more people are seated at one end and may avoid the end which has more people or traffic. Thus, the system may leverage the positioning ability of BLE beacons to direct user 105 through crowd traffic.

The system also may track user 105's movements and may provide guidance for user 105 to reach various places in the public event. Assuming that the majority of customers in the public event are detectable via BLE beacons, the system may track and monitor crowd traffic within the public event. Thus, the system may suggest shortest and least congested routes to user 105. For example, during halftime of a game, many people may move toward amenities such as food/drink vendors and restrooms. The system may provide guidance to each customer to help control and spread crowd traffic to prevent over-congestion in particular areas of the public event. For example, user 105 may use user device 110 to find a nearest drink vendor near user 105. The system may present directions to user 105 via user device 110. The directions may be generated based on crowd traffic, such that a shorted and least congested route is determined. The directions may provide step-by-step instructions to user 105 in real time. Further, the directions may change in real time based on new crowd traffic information when user 105 is en route to the destination. Thus, by leveraging BLE beacons' positioning capability, real time tracking of user positions and crowd traffic may be used to provide real-time and dynamic directions to the user.

At step 318, the system may poll user 105 regarding various locations visited by user 105 in the public event in real time. For example, when user 105 arrives at the assigned seat, the system may initiate a survey regarding the assigned seat on user device 110. The survey may include questions regarding the cleanliness of the seat, the view from the seat, the accessibility of the seat to various amenities, the dynamic of crowds around the seat, and etc. When user 105 visits a vendor, the system may ask user 105 to take a survey about the vendor including questions about the quality of food/merchandise, price, service, wait time, and etc. Other locations, such as restroom, restaurants, parking lots, and etc, may also be surveyed using similar polling process. Thus, various locations in the public event may be surveyed by various customers in real time when customers are visiting the locations to obtain genuine comments from customers.

By using the above process 310, the system may provide directions and guidance to help user 105 navigate in the public event. Further, the movement of the crowd may be monitored to help user 105 choose least congested path to a destination within the public event. The system also may invite user 105 to take surveys about the locations visited by user 105 in real time, such that the user's first and genuine impressions regarding the locations may be collected

The above processes 200, 300, and 310 may be executed by user device 110. In some embodiments, the processes 200, 300, and 310 may be executed at merchant device 140. In some other embodiments, above processes 200, 300, and 310 may be executed by one or both of user device 110 and merchant device 140 in coordination with each other.

The following are exemplary scenarios in which the above processes 200, 300, and 310 may be implemented.

### Example 1

A user is a fan of ice hockey and enjoys going to ice hockey games at a local stadium during hockey season. The user uses a ticket purchasing application on a mobile device to purchase tickets for ice hockey games. The ticket purchasing application allows the mobile device to interact with a server of an online ticket exchange service provider. The ice hockey stadium has a network of Bluetooth beacons installed throughout the stadium. Thus, when the user attends an ice hockey game, the seating location and movements of the user are monitored via the network of Bluetooth beacons. The online ticket exchange service provider analyzes the user's previous seating positions and movements to infer user preferences. Based on the user's preferences, the online ticket exchange service provider determines that user is interested in future ice hockey games at the local stadium. Further, the online ticket exchange service also determines that the user prefers center ice seats. Thus, the online ticket exchange service provider generates offers for tickets to an ice hockey game for seats at center ice and sends the offers to the user via email. The user sees the offers and decides to attend the ice hockey game. The user purchases the tickets for the center ice seats for the ice hockey game.

On the game day, the user arrives at the stadium. The user's mobile device automatically detects that the user has entered the stadium by detecting BLE signals from the network of Bluetooth beacons at the stadium. The mobile device begins to monitor and forward the user's locations and movement to the online ticket exchange service provider. The online ticket exchange service provider receives the user's locations and movement from the mobile device continuously in real time. The online ticket exchange service provider begins to provide real time service to the user based on the user's locations.

As the user enters the stadium, the online ticket exchange service offers to provide directions to the user's assigned seat. In particular, the online ticket exchange service generates a route from the user's current location to the location of the assigned seat. Further, the online ticket exchange service provider receives the location and movements of other users in the stadium. Thus, the online ticket exchange service provider generates a shortest and least congested route to the assigned seat for the user.

After the user is seated at the assigned seat, the online ticket exchange service provider requests that the user provides a survey of a first impression about the assigned seat. The user provides ratings and comments about the cleanliness, field of view, level of comfort, price, accessibility, nearby amenities of the assigned seat. The online ticket exchange service provider stores the ratings and comments for future reference.

The online ticket exchange service provider also searches and presents various amenities near the user's assigned seat, such as restrooms, vendors, public phones, exits, and etc. to the user at user's mobile device. Thus, the user may be informed of the closest amenities. After the game starts, the user decides to purchase a sandwich. The user uses the mobile device to find the nearby food vendors and selects a sandwich vendor. The online ticket exchange service provider generates a shortest and least congested route from the user's seat to the sandwich vendor. Thus, the user is able to navigate to the sandwich vendor with ease. After getting the sandwich, the online ticket exchange service provider notes that the user's friend is also attending the same hockey game at a different section of the stadium. The online ticket exchange service provider finds seats near the friend and offers to upgrade the user's seat to be near the user's friend. The user accepts the upgrade and pays a fee for the upgrade. The online ticket exchange service then directs the user to the upgraded new seat. The user is able to meet and enjoy the game with friends. Further, the online ticket exchange service posts the user's original assigned seat for sale, such that others may utilize the original assigned seat.

After the game ends, the online ticket exchange service tracks the crowd traffic exiting the stadium and provides the user with the shortest and least congested route to exit the stadium. Thus, by leveraging the network of Bluetooth beacons in the stadium, additional services and guidance may be provided to the user to improve customer experience and to increase sales.

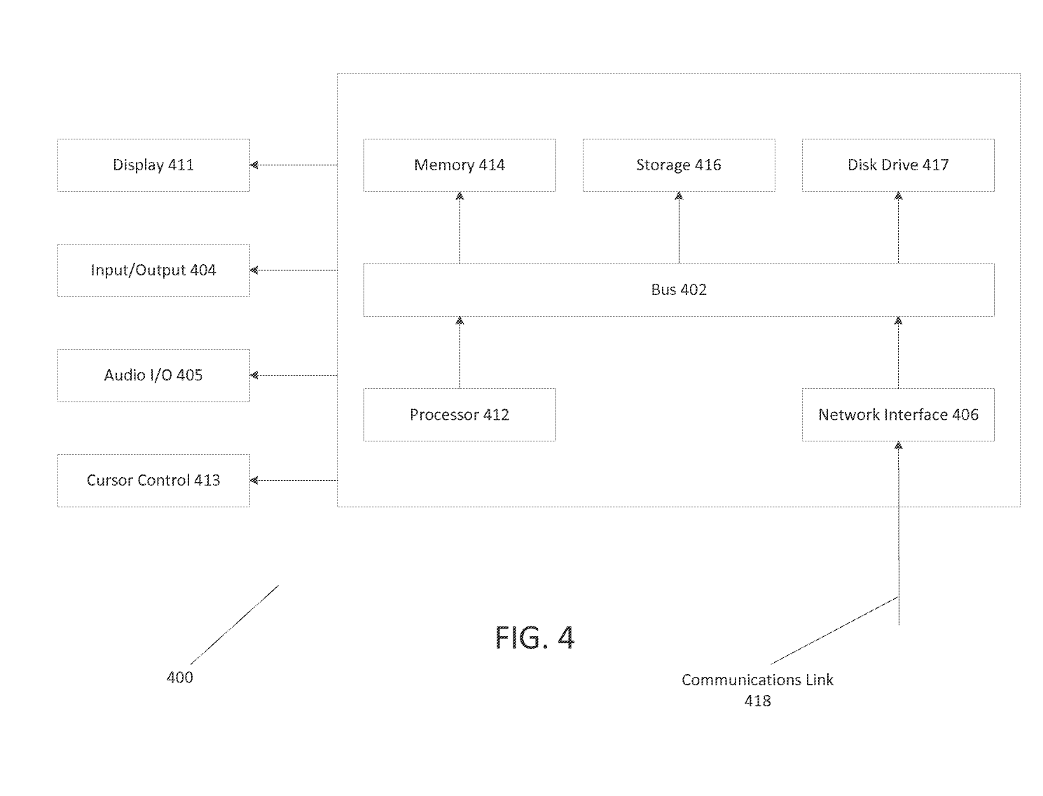

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing information about a user account, wherein the information comprises a user's preferences related to events; and
one or more processors in communication with the memory and adapted to:
receive a location of the user at an event detected by a network of Bluetooth beacons installed at the event;
determine the user's preferences based, at least in part, on the location of the user in the event; and
send offer information to the user based on the user's preferences.

2. The system of claim 1,
wherein the user's preferences comprise a seat location at an event, and
wherein the one or more processors are further adapted to generate an advertisement for a ticket to a future event as the offer information based on the seat location.

3. The system of claim 1, wherein the one or more processors are further adapted to determine that the location of the user in the event is a location of the user's assigned seat when the user is stationary at the location of a seating area for more than a predetermined time during the event.

4. The system of claim 3, wherein the one or more processors are further adapted to survey the user for ratings and comments regarding the location of the user at the event.

5. The system of claim 3, wherein the one or more processors are further adapted to:
determine, via the network of Bluetooth beacons installed in the event, that the user prefers another seat when the user is away from the assigned seat for more than a period of time during the event; and
offer an upgraded seat to the user based on the user's preferences.

6. The system of claim 5, wherein the one or more processors are further adapted to:
identify, based on the user's social network, a friend of the user who is attending the event;
detect a location of the friend via the network of Bluetooth beacons installed at the event; and
determine the upgraded seat based on a location of the user's friend in the event.

7. The system of claim 5, wherein the one or more processors are further adapted to offer to sell the user's assigned seat to another user when the user is upgraded to the upgraded seat or when the user leaves the event.

8. The system of claim 1, wherein the one or more processors are further adapted to:
determine amenities of the event near the location of the user,
receive the user's selection of one of the amenities; and
generate directions from the user's location to the selected amenity.

9. The system of claim 1, wherein the one or more processors are further adapted to:
receive locations of other users detected by the network of Bluetooth beacons in the event;
monitor crowd traffic based on the locations of other users; and
generate directions based on the crowd traffic to avoid congestion.

10. A method comprising:
receiving, by a processor, a location of a user at an event detected by a network of Bluetooth beacons installed at the event;
determining, by the processor, the user's preferences based, at least in part, on the location of the user at the event; and
sending, by the processor, offer information to the user based on the user's preferences.

11. The method of claim 10,
wherein the user's preferences comprise a seat location at an event, and
wherein the method further comprises generating an advertisement for a ticket to a future event as the offer information based on the seat location.

12. The method of claim 10 further comprising determining that the location of the user in the event is a location of the user's assigned seat when the user is stationary at the location of a seating area for more than a predetermined time during the event.

13. The method of claim 10 further comprising surveying the user for ratings and comments regarding the location of the user at the event.

14. The method of claim 12 further comprising:
determining, via the network of Bluetooth beacons installed at the event, that the user prefers another seat when the user is away from the assigned seat for more than a period of time during the event; and
offering an upgraded seat to the user based on the user's preferences.

15. The method of claim 14 further comprising:
identifying, based on the user's social network, a friend of the user who is attending the event;
detecting a location of the friend via the network of Bluetooth beacons installed at the event; and
determining the upgraded seat based on a location of the user's friend in the event.

16. The method of claim 14 further comprising offering to sell the user's assigned seat to another user when the user is upgraded to the upgraded seat or when the user leaves the event.

17. The method of claim 10 further comprising:
determining amenities of the event near the location of the user;
receiving the user's selection of one of the amenities; and
generating directions from the user's location to the selected amenity.

18. The method of claim 10 further comprising:
receiving locations of other users detected by the network of Bluetooth beacons in the event;
monitoring crowd traffic based on the locations of other users; and
generating directions based on the crowd traffic to avoid congestion.

19. A non-transitory machine-readable medium comprising a plurality of machine-readable instructions which when executed by one or more processors are adapted to cause the one or more processors to perform a method comprising:
receiving a location of a user at an event detected by a network of Bluetooth beacons installed at the event;
determining the user's preferences based, at least in part, on the location of the user at the event; and
sending offer information to the user based on the user's preferences.

20. The non-transitory machine-readable medium of claim 19,
wherein the user's preferences comprise a seat location at an event, and
wherein the method further comprises generating an advertisement for a ticket to a future event as the offer information based on the seat location.
